(19) United States
(12) Patent Application Publication
(10) Pub. No.: US 2013/0311943 A1
(43) Pub. Date: Nov. 21, 2013

(54) System for Collecting User Ratings and Reviews in Web Environments

(71) Applicant: Salvador CASTEJON BARCELO, Murcia (ES)

(72) Inventor: Salvador CASTEJON BARCELO, Murcia (ES)

(21) Appl. No.: 13/473,645

(22) Filed: May 17, 2012

(51) Int. Cl. G06F 3/048

(52) U.S. Cl. 715/810

(57) ABSTRACT

This invention relates to software computing systems and, more specifically, to systems for voting, rating, sharing content and/or posting comments on, for example, web pages and/or web applications, and preferably those software computing systems which include a graphical interface configured with elements that, on closing, allow the sending of data structures relating to web content ratings, preferences, comments or recommendations made by the user.

### FIELD OF THE INVENTION

This invention relates to software computing systems and, more specifically, to systems for voting, rating, sharing content and/or posting comments on social or communication networks, websites, web applications, windows-based graphical interfaces, window gadgets (“widgets”), images, videos, audio, text and, in general, any element present in the graphical user interface of a software application that can be closed, has a positive or negative value for the user and that users may wish to discuss and/or share with other users.

### BACKGROUND

Today, when accessing the Internet through, for example, the world wide web (WWW), many users make use of voting, content sharing and comment publishing systems so their likes and preferences are also accessible to other persons accessing the net and Internet Service Providers. Therefore, the opinion of a large number of users can be used for various purposes, such as statistical analysis of behavioural data, implementation of decision support systems, classification of search engine content, or information sharing within user communities, among other possibilities. While the above activities are already available to Internet users in a variety of formats, the way of realising them, to date, has basically been divided into three types of system:

(1) Software applications (or APIs): These applications are programmed to be inserted into pages/web applications, through installation and configuration by the administrator of these pages, and include the tools a user needs to perform a particular activity (e.g. vote for one of several options, post comments, edit content, etc.). These systems are incorporated into, approximately, only 20% of the web pages on the Internet, in the form of various applications with, for the most part, independent and incompatible modes of operation.

(2) “Plug-ins” or “add-ons” that can be installed in a web browser: These software packages are installed within the user's web browser, incorporating the means for it to perform a particular activity (voting, commenting, sharing data, etc.). These systems have the disadvantage that, not being included natively in the default version of the browsers with which they are associated, they are only accessed and used by people with more experience or knowledge, who are able to install them properly, or find them on, for example, specific ‘plug-in’ or ‘add-on’ download sites. In addition, having to resort to using a specific ‘plug-id for each activity overly complicates web browsing and the retrieval of web pages for the user, as it usually involves new menus or buttons that the user needs to operate and which add to those already integrated into the web browser (e.g. go forward, go back, web address, favourites, etc.). This results in more time spent navigating web pages and, in practice, means that users dispense with using the “plug-ins” when they do not want to linger for too long on a specific page.

(3) Integrated search engine tools: This system includes functionality installed on Internet search web sites, such as the Google “+1” tool, which allows users to rate the results offered by these sites when performing a query, so that the user's selection can be included in the search engine result ranking algorithm and used in subsequent searches, allowing the results to both be customised for a particular user (based on their preferences) and take into account the common preferences of a group of users. The problem with this type of functionality is that, when a user makes a query, they cannot know in advance if a web link provided by the search engine will take them to the content they want, unless they have already visited the page linked to by the search engine and checked it. The voting system is, therefore, not highly operational, requiring the user to go back along their navigation path to vote for the right content, or leave the vote for another time when they make a similar query. Also, as for options (1) and (2) discussed above, almost every voting system is closed and independent to each specific search engine, which prevents data sharing between the different engines utilised by users.

Therefore, within the scope of this invention, there is a need to overcome the drawbacks and problems mentioned above, so that Internet users can vote, rate, comment and share web content easily, quickly, conveniently, intuitively and interactively without incurring delays in their browsing time or needing to go backwards once they have left the desired content, and for the functionality to be compatible across multiple platforms. This invention is designed to satisfy this need.

### SUMMARY OF THE INVENTION

One object of this invention is a storage medium which is readable by a computing system, containing instructions which are executable by a software application, where this software application has one or more user interface elements arranged in a graphical user interface and where the instructions hosted in the storage medium, when executed, perform operations including displaying an “action and close” button in at least one of the interface elements within the graphical user interface. The “action and close” button is configured to send data structures to a data network and close the interface element in one sole operation. Preferably, the data structures sent by the “action and close” button will include information relating to the rating of the web content, user preferences, comments and recommendations, or any other data that the user wishes to share via the network. For example, the information could be a favourable rating of a web page that they have visited, so that this rating can be shared and be of use to other users or web-based information services providers (search engines, social networks, online retailers, etc.). Thanks to the linking of the completed action and the closure of the interface element, by clicking the single “action and close” button, users can simply and naturally integrate social Internet behaviour with the usual process of moving between different elements (web pages, documents, videos, etc.), closing them as they visit them. In this way, we can guarantee that the information sent by users is transmitted after they have explored the content, and not before, as is the case with other state of the art systems. Furthermore, the association of sending social information with closing the interface element in one single action, by clicking the “action and close” button, means users makes a connection between the optional “social” action and the obligatory action of closing said element (for example, the tab on a web browser) when they want to leave the content. This notably increases the number of social actions made naturally by the user and, consequently, increases the social information shared by the client-server system of the invention.

In one embodiment of the invention, the interface elements are selected from web pages, web applications, windows, tabs, widgets, images, videos, songs and/or text. This gives the invention great adaptability to most content that can be used or shared by a user, for example, over the Internet. This adaptability allows the functionality of the invention to be integrated into a large number of supports, such as web browsers, windows-based graphical interfaces, search engines, social networks, etc.

In another embodiment of the invention, the operations executable by the software application include, additionally, displaying a “close” button substantially near to the “action and close” button, where this “close” button is configured to close the interface element. The term “substantially near” when referring to these two buttons on the graphical user interface of the invention should be interpreted as these buttons being so positioned that any third button on the graphical user interface is further away from both of the buttons than they are from each other. The “close” button is a conventional interface element closure button (for example, the “X” button on the majority of web browser tabs), which is useful in those cases where the user wishes to leave the visited content without completing any social action.

In another embodiment of the invention, the “action and close” button is configured to send different data structures depending on how long the “action and close” button is held down, the number of clicks made on the “action and close” button, positioning the cursor over the “action and close” button for a specific amount of time, which button is clicked on a mouse or touchpad, or a combination of the above. This gives the invention great versatility, enabling it to easily adapt to the specific requirements of the user.

In an additional embodiment of the invention, the “action and close” button is configured to send data structures only when the “action and close” button is held down for a specific amount of time, the “action and close” button is clicked a specific number of times, the cursor is positioned over the “action and close” button for a specific amount of time, a specific button is pressed on the mouse or touch pad, or a combination of the above. This allows the “action and close” button to function as a “close” button in those cases where the user wishes to close an interface element (window, tab, video, text, web page, etc.) without completing any social action.

In an additional embodiment of the invention, the application's graphical user interface includes an “action to complete” menu configured to send data structures to the data network, which also includes one or more subinterfaces for configuring and sending actions. This allows different social tools relating to different actions to be displayed in the same environment. There could be, for example, a content rating subinterface, a comment sending subinterface, a content sharing subinterface and/or a social or communication network subinterface.

In one embodiment of the invention, access to the “action to complete” menu is achieved by one of the following methods: Clicking the mouse or touchpad for a specific time period; “double clicking” with the mouse or touchpad; positioning the cursor over the “action and close” button for a specific time period; or clicking a specific button on the mouse (for example, right clicking). This, again, provides more versatile access to the menu.

In one embodiment of the invention, the “action to complete” menu includes a second “action and close” button which also confers the advantages of this button to the subinterfaces for configuring and sending actions.

In one embodiment of the invention, information is sent to the data network via a service linked to a search engine, a social network, a blogging or microblogging service, or a combination of the above, through the configuration of the application interface. This makes the invention highly compatible with existing Internet social platforms.

In one embodiment of the invention, the application includes a web browser. This creates a natural association between completing social actions and exploring web content.

Another object of this invention is a method which is implementable by a computer using an application which includes the following steps:
showing one or more interface elements of a graphical user interface.
sending data structures to a data network and closing an interface element included in the graphical user interface by clicking an “action and close” button, also included in this interface element.

For preference, the interface elements include web pages, web applications, windows, tabs, widgets, images, videos, songs and/or texts.

In one embodiment of the method of the invention, different data structures are sent by holding down the “action and close” button for a specific amount of time, by clicking the “action and close” button a specific number of times, by positioning the cursor over the “action and close” button, by clicking a specific button on the mouse or touchpad (for example, right clicking), or a combination of the above.

In one embodiment of the method of the invention, different data structures are sent only by holding down the “action and close” button for a specific amount of time, by clicking the “action and close” button a specific number of times, by positioning the cursor over the “action and close” button, by clicking a specific button on the mouse or touchpad (for example, right clicking), or a combination of the above.

In an additional embodiment of the method of the invention, the data structures are sent to the data network via an “action to complete” menu included in the user interface, which also includes one or more subinterfaces for configuring and sending actions.

In one embodiment of the method of the invention, access to the “action to complete” menu is achieved by holding down a button on the mouse or touchpad for a specific time period; “double clicking” with the mouse or touchpad; positioning the cursor over the “action and close” button for a specific time period; or clicking a specific button on the mouse.

Another object of this invention is a computing system that includes a storage medium in accordance with the embodiments described in this document.

In one embodiment of the computing system of the invention, this system includes one or more clients and one or more servers connected via a data network, where each client includes a programmed software application that can be used by a user and that is configured to be able to communicate with one or more of the servers and/or clients via the network.

In one embodiment of the computing system of the invention, the software application includes a web browser.

In another embodiment of the computing system of the invention, the software application includes a graphical user interface which allows it to send data to the server.

In an additional embodiment of the computing system of the invention, the data transmitted from a client via the network are shared with various servers within the computing system and/or with the clients included within this system. For preference, the system is configurable by the user to only share the information they choose.

In one embodiment of the computing system of the invention, the software application included in each client comprises a transmission service for data via the network and each server includes a processing medium for these data.

Other features and advantages of the invention are apparent from the figures that accompany this document, as well as the detailed description of the invention which is included in the following paragraphs.

### BRIEF DESCRIPTION OF THE FIGURES

FIG. 1 shows a block diagram representing a computing system based on one embodiment of the invention.

FIG. 2A shows an example of a graphical user interface in a state of the art web browser, which includes a tab structure configured to separate different documents, web pages and web applications.

FIG. 2A shows an example of a graphical user interface based on one embodiment of this invention, where the tabs in a web browser include an “action and close” button.

FIG. 2C shows an example of a graphical user interface based on one embodiment of this invention, which includes one or more “close” buttons substantially near to the “action and close” buttons.

FIG. 2D shows an example of a graphical user interface based on one embodiment of this invention, which includes one or more “close” buttons, one or more “action and close” buttons and an “action to complete” menu which includes a content rating subinterface, a comment sending subinterface and a content sharing subinterface.

FIG. 2E shows an example of a graphical user interface based on one embodiment of this invention, where the “action to complete” menu includes a content rating subinterface, a comment sending subinterface, a content sharing subinterface, a comment display subinterface and a social and communication network subinterface.

### DETAILED DESCRIPTION OF THE INVENTION

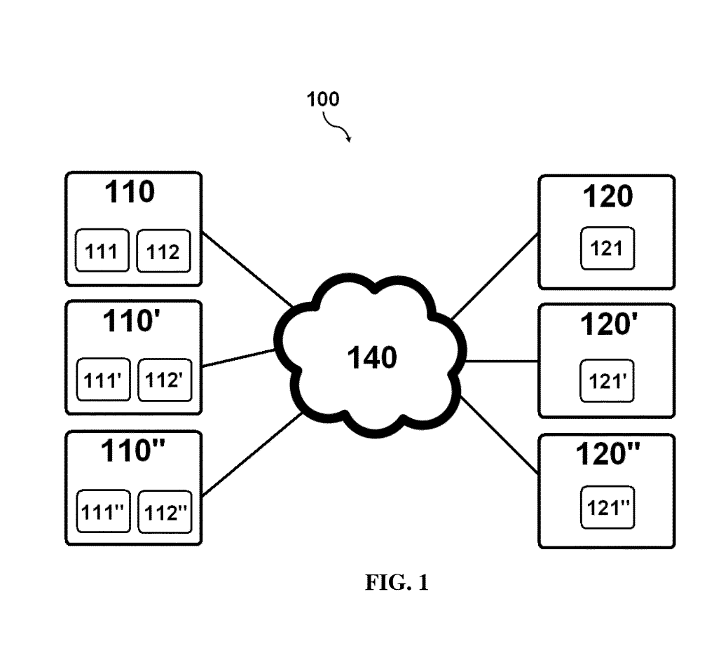

FIG. 1 is a block diagram which represents a computing system (100) on the basis of this invention, where this system includes one or more clients (110, 110′, 110″) and one or more servers (120, 120′, 120″) connected via a data network (140). Each client (110, 110′, 110″) comprises a programmed software application (111, 111′, 111″), where this application is preferably a web browser, which can be used by a user and which is configured to be able to communicate with one of more of the servers (120, 120′, 120″) and/or clients (110, 110′, 110″) via the network (140). This software application (111, 111′, 111″) comprises a graphical user interface that allows it to send data to the server (120, 120′, 120″), where such data preferably comprises information on user opinions, preferences and feedback concerning one or more elements of the graphical user interface, such elements being, for example, websites, web applications, windows, tabs, widgets, images, video, audio and/or text. While FIG. 1 shows, by way of an example, a computing system (100) comprising three clients (110, 110′, 110″) and three servers (120, 120′, 120″), it should be derived by a skilled in the art that other combinations of client and server are equally possible within the scope of the invention.

The data network (140) represents the communication route between the client (110, 110′, 110″) and the server (120, 120′, 120″), as well as the clients (110, 110′, 110″) between themselves and the servers (120, 120′, 120″) between themselves. For preference, the network (140) will include standard Internet technology and/or protocols. Thus, the network (140) can transmit data via, for example, Ethernet technology, 802.11 technology, an Integrated Services Digital Network (“ISDN”), an asynchronous transfer mode (“ATM”) and/or other state of the art standards. Similarly, the network protocols for the network (140) may include one or more of the following: Transmission Control Protocol/Internet Protocol (“TCP/IP”), Hypertext Transport Protocol (“HTTP”), Simple Mail Transfer Protocol (“SMTP”), File Transfer Protocol (“FTP”), as well as other protocols known and commonly used within communication networks. The data exchanged on the network (140) can be represented using technologies and/or formats such as Hypertext Markup Language (“HTML”), Extensible Markup Language (“XML”), etc.

Data transmitted from a client (110) via the data network (140) can be shared both with the various servers (120, 120′, 120″) on the computing system (100), and with the clients (110, 110′, 110″) included in this system. In one embodiment of the invention, the application (111, 111′, 111″) included in each client (110, 110′, 110″) includes a data transmission service (112, 112′, 112″) via the network (140) and each server (120, 120′, 120″) includes a processing medium (121, 121′, 121″) for these data. Both the data transmission service (112, 112′, 112″) of the client (110, 110′, 110″) and the processing medium (121, 121′, 121″) of the server (120, 120′, 120″) comprise communication technologies and protocols configured to respectively send and receive data over the network (140) via, for example, the previously referenced standards.

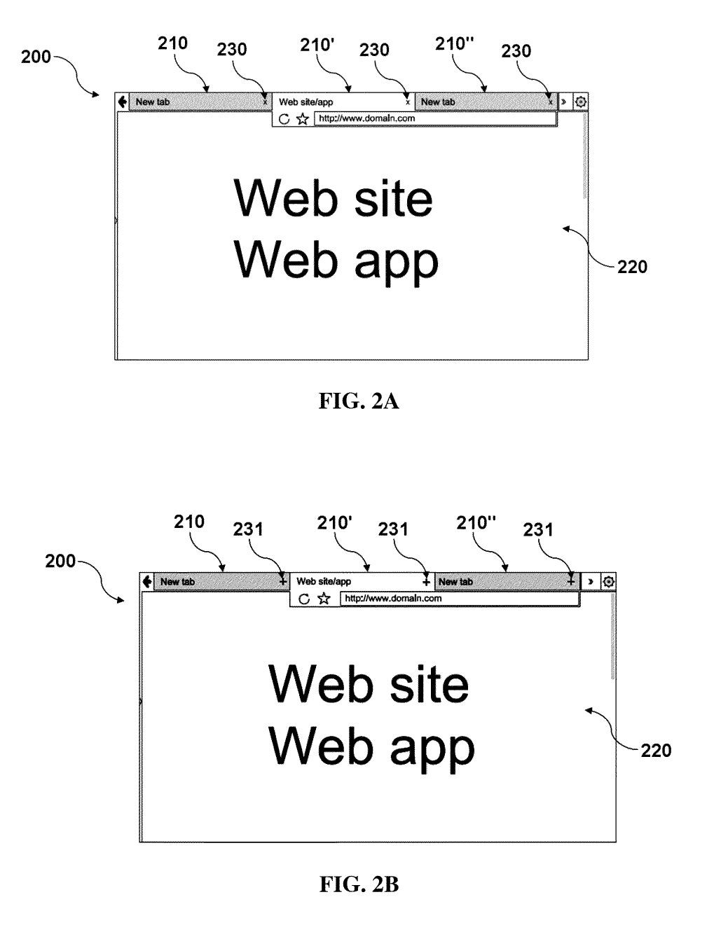

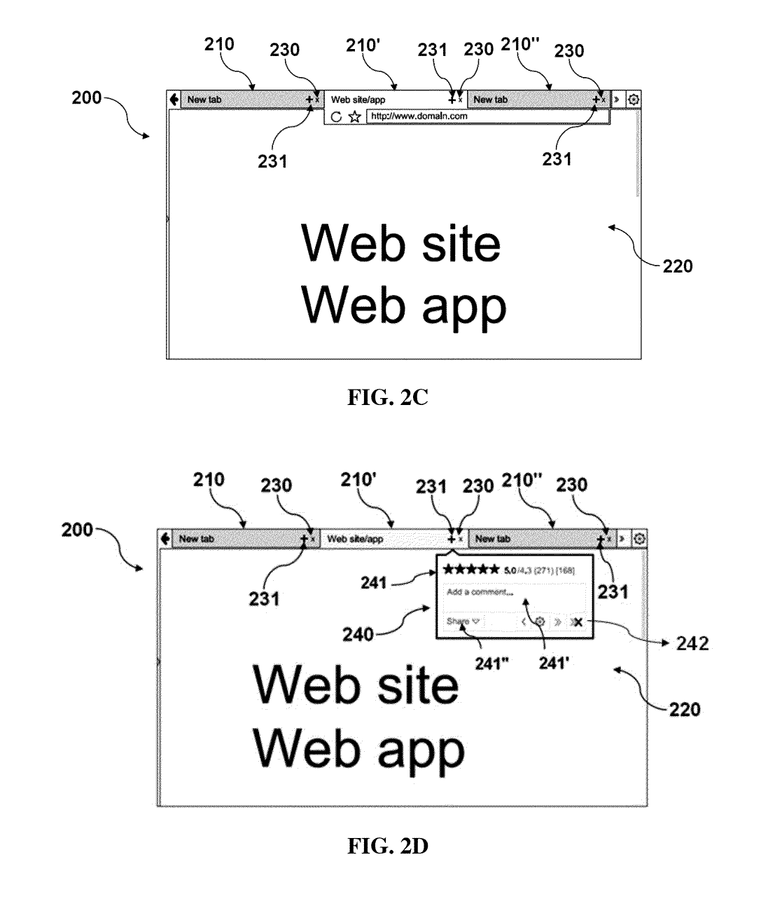

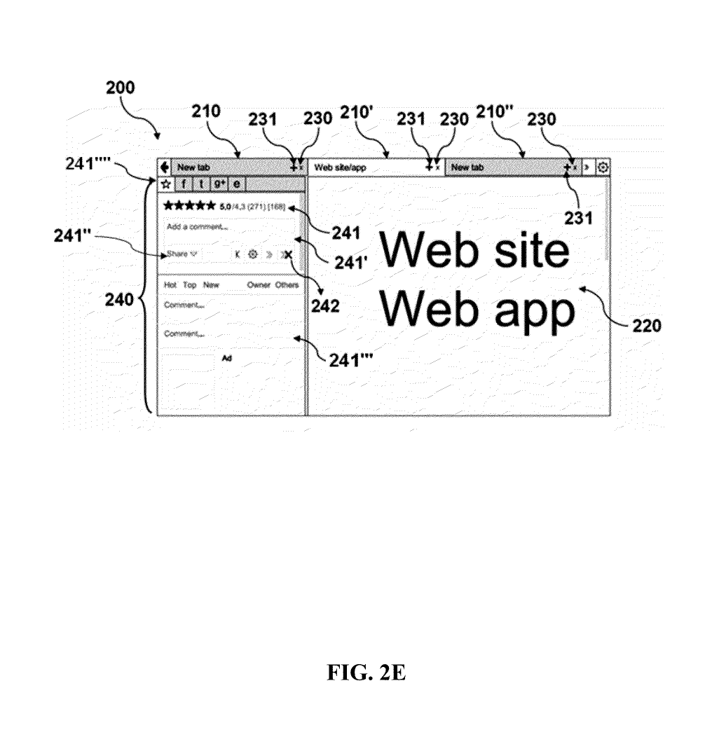

FIG. 2A of this document shows an example graphical user interface (200) in a state-of-the-art web browser, comprising a tab structure (210, 210′, 210″) configured to separate the various documents, web pages or web applications (220) visited by the user, wherein each tab is home to one of these documents, web pages or applications (220), and where it is possible to view each of them when the user clicks on these tabs using, for example, a mouse or a touch pad on a specific tab (210, 210′, 210″), hiding the remaining documents, pages or applications (220) of the graphical user interface (200). Each tab has a “close” button (230) which, on being clicked by the user, closes the tab, eliminating the web document from the interface (200). The tab structure described and illustrated in FIG. 2A (where the “close” button (230) is represented by an “X” symbol on the tabs) is adopted by the vast majority of web browsers used today, such as Internet Explorer, Mozilla Firefox and Google Chrome, among others.

In one embodiment of the objects of this invention represented by FIG. 2B, and unlike the well-known web browsers, the tabs (210, 210′, 210″) include an “action and close “button (231), where this button is configured through the graphical user interface (200) of the web browser to send data to the network (140) and close the tab (210, 210′, 210″), in one single user operation. In FIG. 2B, the “action and close” button (231) is represented by a “+” symbol in the browser tab. Preferably, the data sent using the “action and close” button (231) will include information regarding the rating of web content, user preferences, comments and recommendations, or any other information that the user wishes to send to the server (120, 120′, 120″) or to another client (110, 110′, 110″), through the data transmission service (112, 112′, 112″). For example, the information could be a favourable rating of content that they have visited, whether this is a document, web page or web application (220), so that this rating can be shared and be of use to other users or web-based information services providers (search engines, social networks, online retailers, etc.). Thanks to the association of the action performed (in the example above, sending a content rating) and the closing of the tab by pressing a single button (231), the user can naturally and easily incorporate social behaviours into the network (140) along with the usual process of moving between different web content, closing the tabs as they visit them. In this way, as previously explained, we can guarantee that the information sent by the user is sent after they have explored the content, and not before, as is the case with other state of the art systems. Furthermore, the association of sending social information with closing the tab in one single action, by clicking the “action and close” button (231), means the user makes a connection between the optional “social” action and the obligatory action of closing said tab when they want to leave the content. This notably increases the number of social actions that the user makes quite naturally and, consequently, increases the social information shared by the client of the invention (110, 110′, 110″) and server (120, 120′, 120″) system.

In order to allow the user the option to not send social information using the web browser (111, 111′, 111″) at times when they do not want to, in one embodiment of the invention, the “action and close” button (231) is configured to perform different actions depending on how long you press the button (for example by using a mouse or touchpad), so that the social action associated with the button is completed only by clicks of a certain range of duration, and for other durations it merely closes the tab, without transmitting any information to the network (140). As an alternative, it is also possible to complete the social action associated with the “action and close” button (231) if the user clicks or double clicks respectively on the button. Other alternatives can include, for example, positioning the cursor of the mouse or touchpad over the “action and close” button (231) to complete the associated action, or pressing various buttons on the mouse or touchpad (for example, right clicking). Similarly, as is derivable by a skilled in the art, other combinations of the examples given, as well as other equivalent systems, could also be used within the scope of the invention.

In another embodiment of the invention, as demonstrated in FIG. 2C, one or more of the tabs (210, 210′, 210″) in the graphical user interface (200) of the web browser has one or more “close” buttons (230) and, additionally, one or more “action and close” buttons (231), preferably situated substantially near to the “close buttons (230). The term “substantially near” when referring to two buttons on the graphical user interface (200) of the invention should be interpreted as these buttons being so positioned that any third button on the graphical user interface is further away from both of the buttons than they are from each other. In this embodiment, it is possible to incorporate into the same tab, the function of closing without completing a social action, using the “close” button (230), and the “action and close” function using the corresponding button (231). The close proximity of the two buttons on the interface (200) is especially convenient for saving the user time and for facilitating social actions, as the user only has to select one of the two buttons to, for example, send or not send a favourable vote for the content they have visited before closing the tab (210, 210′, 210″) when this content is displayed. The proximity of the two buttons means that completing social actions does not involve additional effort by the user nor a delay in their content visiting activity.

In one embodiment of the invention, which is represented in the example in FIG. 2D, one or more “close” buttons (230) or one or more “action and close” buttons include an “action to complete” menu (240) which allows the user to define which social action will be completed before closing the tab (210, 210′, 210″). Access to this menu (240) can be configured using various formulae, as is derivable by an expert in the field. For example, it is possible to access the “action to complete” menu (240) by clicking with a mouse or touchpad for a specific duration on this “action and close” button (231) as configured by the manufacturer or user. Similarly, it is also possible to configure access to the menu (240) by “double clicking”, by positioning the cursor of the mouse (or touchpad) over the “action and close” button (231) or over the close button (230) for a default duration or one configured by the user. In addition to the above alternatives, as well as the combination thereof, other possibilities among those used in the state of the art for the display of menus on interfaces can also be used as the object of the invention (for example, by right clicking).

The “action to complete” menu (240) on the user interface (200) includes one or more subinterfaces for configuring and sending actions (241, 241′, 241″) as well as, for example, a content rating subinterface (241), a comment sending subinterface (241′) or a content sharing subinterface (241″). In one embodiment of the invention, the “action to complete” menu (240) of the user interface (200) can be configured to be closed, along with the tab (210, 210′, 210″), when one or more actions are completed in the subinterfaces for configuring and sending actions (241, 241′, 241″), for which reason it is possible to include a second “action and close” button (242) in the “action to complete” menu (240). In another embodiment of the invention, the “action to complete” menu (240) allows the completion of one or more actions via the subinterfaces for configuring and sending actions (241, 241′, 241″), without the need to close the tab.

In one embodiment of the invention (FIG. 2E), the “action to complete” menu (240) is configured into the side of the web browser interface (200), allowing it to be constantly visible to the user, or to become visible on clicking the “action and close” button (231), or to become visible on clicking the “<” button on the interface. In the same was as in other embodiments, the “action to complete” menu (240) within the user interface (200) can include one or more subinterfaces for configuring and sending actions (241, 241′, 241″, 241′″, 241″″). In the example in FIG. 2E, the “action to complete” menu (240) includes a content rating subinterface (241), a comment sending subinterface (241′), a content sharing subinterface (241″), a comment display subinterface (241′″) and a social and communication network subinterface (241″). In another embodiment of the invention, the “action to complete” menu (240) allows the completion of more than one action via the subinterfaces for configuring and sending actions (241, 241′, 241″, 241′″, 241″″), for which reason it is possible to include a second “action and close button” (242) in this “action to complete” menu (240) (if desired), and also another for sending “>>”.

In any of the embodiments above, social information can be sent to the network (140) in various information formats in accordance with the rules set by search engines, social networks, blogging and microblogging services, etc. By configuring the interface (200) web browser (111, 111′, 111″) and the data transmission service (112, 112′, 112″). Thus, for example, it is possible to configure the “close” button (230), the “action and close” button (231) or the “action to complete” menu (240) so the social information sent is accepted by Google, Google+, Facebook, Twitter, etc. This helps to increase the information collected through user feedback and to integrate diverse information publication and sharing systems in a single tool (the web browser), all without increasing the time taken by the user to navigate web documents (220), resulting in an improvement at both client (110, 110′, 110″) and server level (120, 120′, 120″).

Another object of this invention relates to a method of transmitting social information implemented in a computing system, from a client (110, 110′, 110″) to a server (120, 120′, 120″), via the network (140). In this method, firstly, the user of the client (110, 110′, 110″) accesses a web page/application (220) hosted in a tab (210, 210′, 210″) in the user interface (200) of the web browser (111, 111′, 111″). After visiting the web page/application (220) and reviewing its content, the user sends social information to the network (140) using the “close” button (230), “action and close” or via the “action to complete” menu (240), as appropriate according to one or another of the embodiments of the invention described above. Like this, the information is sent to the network (140) and the tab (210, 210′, 210″) can be closed in a single operation. Depending on the instructions given by the user via the interface (200) and the data transmission service (112, 112′, 112″), the social information is sent to one or several clients (110, 110′, 110″), one or several servers (120, 120′, 120″) or a combination thereof.

The descriptions above of the embodiments of the invention have been given for illustrative purposes and must not be seen to be an exhaustive nor a restrictive description of its objects. Other embodiments and combinations thereof are possible, as is derivable by an expert in this field. In this way, in the embodiments of the invention illustrated in FIGS. 2B-2E, we have demonstrated a graphical interface whose interface elements are web browser tabs. However, the object of the invention is equally applicable to other elements such as windows, widgets, images, videos, audio and/or text and any type of content within the graphical interface of the computing system that can be closed, has a positive or negative value for the user and that users may wish to discuss and/or share with others.

Some aspects of this application relate to embodiments of the invention in terms of algorithms and symbolic representations of information data operations. The descriptions of these algorithms and representations, although described functionally or logically, must be understood as referring to their embodiment by means of a programmed computer, electronic, microelectronic or similar circuits. In this way, the embodiments referred to above, and their functionality, can be realised using software, hardware, firmware or a combination thereof.

Any of the steps, operations and processes described herein can be carried out or implemented through software and/or hardware modules, alone or in combination with other devices. In one embodiment of this invention, the software modules are implemented in a program including a computer readable medium, which can be executed by said computer processor to perform any of the processes, operations or functions described herein.

The embodiments of the invention can also be referred to an apparatus configured to complete the operations described in this document. This apparatus can be specifically manufactured to carry out the objects of the invention or may comprise a generic computer device adapted and configured by a program stored in a computer. This computer program can be stored in any storage medium suitable for containing electronic instructions, which may be linked to a channel or computer “bus”. In addition, any of the computing systems referred to in this invention can include either a single processor or multiple processors.

Finally, the language used in this application primarily aims to ensure that the object of the invention as well as its inventive step can be easily understood in a functional manner, so the embodiments described herein are not to be interpreted as exhaustive but rather illustrative of the subject of the invention, as delimited by the following claims.

1. Storage medium readable by a computing system (100), which contains instructions executable by a software application (111, 111′, 111″), where this software application comprises one or more interface elements arranged in a graphical user interface (200), the storage medium being characterised by instructions that, when executed, perform operations which include:
displaying an “action and close” button (231) in, at least, one of the interface elements of the graphical user interface (200) wherein this button is configured to send data structures to a data network (140) and close this interface element.

2. Medium in accordance with claim 1 wherein the interface elements are selected from web pages, web applications, windows, tabs (210, 210′, 210″), widgets, images, videos, songs and/or text.

3. Medium in accordance with claim 1 wherein the executable operations for the software application include, additionally:
displaying a “close” button (230) located substantially near to the “action and close£ button (231), where this “close” button (230) is configured to close an interface element.

4. Medium in accordance with claim 1 wherein the “action and close” button (231) is configured to send different data structures depending on how long the “action and close” button (231) is held down, the number of clicks made on the “action and close” button (231), positioning the cursor over the “action and close” (231) button for a specific amount of time, which button is clicked using a mouse or touchpad, or a combination of the above options.

5. Medium in accordance with claim 1 wherein the “action and close” (231) button is configured to send data structures only when the “action and close” (231) button is held down for a specific amount of time, the “action and close” button (231) is clicked a specific number of times, the cursor is positioned over the “action and close” button (231) for a specific amount of time, a specific button is pressed on the mouse or touch pad, or a combination of the above options.

6. Medium in accordance with claim 1 wherein the graphical user interface (200) of the software application (111, 111′, 111″) includes an “action to complete” menu configured to send data structures to the data network, which also includes one or more subinterfaces for configuring and sending actions (241, 241′, 241″, 241′″, 241″″).

7. Medium in accordance with claim 6 wherein the subinterfaces for configuring and sending actions (241, 241′, 241″, 241′″) include a content rating subinterface (241), a comment sending subinterface (241′), a content sharing subinterface (241″), a comment display subinterface (241″) and/or a social or communication network subinterface (241′″).

8. Medium in accordance with claim 6 wherein access to the “action to complete” menu (240) is achieved by holding down a button on the mouse or touchpad for a specific time period; “double clicking” with the mouse or touchpad; positioning the cursor over the “action and close” button (231) for a specific time period; or clicking a specific button on the mouse.

9. Medium in accordance with claim 6 wherein the “action to complete” menu (240) includes a second “action and close” button (242).

10. Medium in accordance with claim 1 wherein the information is sent to the data network (140) via a service linked to a search engine, a social network, a blogging or microblogging service, through the configuration of the interface (200) of the software application (111, 111′). 111″).

11. Medium in accordance with claim 1 wherein the software application (111, 111′, 111″) includes a web browser.

12. Medium in accordance with claim 2 wherein the data sent to the data network (140) include information relating to the rating of the web content, preferences, comments and recommendations by the user of the software application (111, 111′, 111″).

13. Method implementable by a computer using a software application (111, 111′, 111″), comprising the following steps:
display one or more interface elements of a graphical user interface (200).
send data structures to a data network (140) and close an interface element included in the graphical user interface (200) by clicking an “action and close” button (231), also included in this interface element.

14. Method in accordance with claim 13 wherein the interface elements are selected from web pages, web applications, windows, tabs (210, 210′, 210″), widgets, images, videos, songs and/or text.

15. Method in accordance with claim 13 wherein different data structures are sent by holding down the “action and close” button (231) for a specific amount of time, by clicking the “action and close” button (231) a specific number of times, by positioning the cursor over the “action and close” button (231), by clicking a specific button on the mouse or touchpad, or by a combination of the above options.

16. Method in accordance with claim 13 wherein different data structures are sent exclusively by holding down the “action and close” button (231) for a specific amount of time, by clicking the “action and close” button (231) a specific number of times, by positioning the cursor over the “action and close” button (231), by clicking a specific button on the mouse or touchpad, or by a combination of the above options.

17. Method in accordance with claim 13 wherein the data structures are sent to the data network (140) via an “action to complete” menu (240) included in the user interface (200), which also includes one or more subinterfaces for configuring and sending actions (241, 241′, 241″, 241′″, 241′″).

18. Method in accordance with claim 16 wherein the subinterfaces for configuring and sending actions (241, 241′, 241″, 241′″) include a content rating subinterface (241), a comment sending subinterface (241′), a content sharing subinterface (241″), a comment display subinterface (241″) and/or a social or communication network subinterface (241′″).

19. Method in accordance with claim 16 wherein access to the “action to complete” menu (240) is achieved by holding down a button on the mouse or touchpad for a specific time period; by “double clicking” with the mouse or touchpad; by positioning the cursor over the “action and close” button (231) for a specific time period; or by clicking a specific button on the mouse.

20. Method in accordance with claim 16 wherein the data structures are sent to the data network (140) using a second “action and close” button (242) included in the “action to complete” menu (240).

21. Method in accordance with claim 13 wherein information is sent to the data network (140) via a service linked to a search engine, a social network, a blogging or microblogging service, through the configuration of the interface (200) of the software application (111, 111′, 111″).

22. Method in accordance with claim 13 wherein the software application (111, 111′, 111″) includes a web browser.

23. Method in accordance with claim 13 wherein the data structures send to the data network (140) include information relating to the rating of the web content, preferences, comments and recommendations by the user of the software application (111, 111′, 111″).

24. Computing system (100) comprising a storage medium in accordance with claim 1.

25. System in accordance with claim 24, comprising one or more clients (110, 110′, 110″) and one or more servers (120, 120′, 120″) connected via a data network, where each client (110, 110′, 110″) includes a programmed software application (111, 111′, 111″) that can be used by a user and that is configured to be able to communicate with one or more of the servers (120, 120′, 120″) and/or clients (110, 110′, 110″) via the network (140).

26. System in accordance with claim 24 wherein the software application (111, 111′, 111″) includes a web browser.

27. System in accordance with claim 24 wherein the software application (111, 111′, 111″) includes a graphical user interface that allows the user to send data to the server (120, 120′, 120″).

28. System in accordance with claim 24 wherein the data transmitted from a client (110, 110′, 110″) via the network (140) are shared with various servers (120, 120′, 120″) within the computing system (100) and/or with the clients (110, 110′, 110″) included within this system

29. System in accordance with claim 24 wherein the software application (111, 111′, 111″) included in each client (110, 110′, 110″) includes a data transmission service (112, 112′, 112″) via the web (140) and wherein each server (120, 120′, 120″) includes a processing medium (121, 121′, 121″) for these data.
